(19) United States
(12) Patent Application Publication
(10) Pub. No.: US 2023/0227262 A1
(43) Pub. Date: Jul. 20, 2023

(54) Modular Belt Link as well as a Conveyor Belt Assembled from a Plurality of Such Belt Links

(71) Applicant: Ammeraal Beltech Modular A/S, Vejle (DK)

(72) Inventor: Kenneth Westergaard Andersen, Vejle (DK)

(21) Appl. No.: 17/167,143

(22) Filed: Feb. 4, 2021

(30) Foreign Application Priority Data
Feb. 4, 2020 (DK) PA 2020 70069

(51) Int. Cl. B65G 17/08

(52) U.S. Cl. CPC B65G 17/08; B65G 2207/30; B65G 2207/34

(57) ABSTRACT

Modular belt link having a body section, said body section having a forward side and a rearward side, and lateral sides connecting said forward and rearward sides, where said body section has a thickness between a top surface and a rear surface, and further that means are provided along said forward and rearward sides for connecting the modular belt link to other substantially identical modular belt links arranged before and after said modular belt link, characterized in that a plurality of apertures through the thickness are provided, suitable to receive and retain a ball or roller rotatably in each aperture, such that the balls or rollers extend or may be brought to extend above the top surface of the body section where a first plurality of apertures are separated by a first distance x and one or more second apertures are provided spaced from said first plurality of apertures, where when more second apertures are provided they are separated by a second distance y, and where on the bottom surface at least partly into the thickness of the body section one or more cavities suitable to receive sprockets is/are arranged in between at least some of the apertures arranged with the second distance y, and where the first distance x is too short to allow cavities suitable to be engaged by sprockets.

### FIELD OF THE INVENTION

The present invention relates to a modular belt link where a plurality of such modular belt links may be assembled into a conveyor belt.

### BACKGROUND OF THE INVENTION

### Description of the Invention

Conveyor belts made from modular belt links are very well-known in the conveying business and are typically made by an injection moulding process of a thermo plastic material. These types of modular belt links come in a very wide variety of sizes and shapes where each type has special qualities, which makes it especially adaptable to a certain conveying task.

A specific type of these modular belts are provided with rollers or balls extending above the surface of the modular belt links such that for example boxes and the like may move on the surface of the belt and relative to the surface of the belt by action of the rollers. In some embodiments of these types of belts the rollers are replaced by balls such that also unidirectional motions may be contemplated.

The rollers or balls may be activated for example by means underneath the belt such that the rollers can be activated in order to accelerate items carried on the conveyor belt, for example in order to separate items on the belt or the rollers may be activated for sideways motion in order to remove an item from the belt at a certain station.

Also belts where the rollers or balls are not activated are known and referred to as a accumulating belts where items on the conveyor surface may engage a stop for one reason or the other along the conveying path, and due to the rollers and balls the conveyor belt may keep rotating without the item being carried onwards on the conveyor due to the fact that the rollers allow the conveyor belt to pass underneath the item with very little friction due to the provision of the rollers or balls.

Common for most of these types of conveyor belts is the fact that the endless conveyor belt is arranged around drive cylinders in each end. At least one of the drive cylinders is powered such that by rotating the drive cylinder it will by means of sprockets engage the underside of the modular conveyor belt and in this manner transfer the torque from the drive cylinder to the conveyor belt which thereby is forced into motion.

Depending on the character of the goods to be conveyed on the conveyor belt and the conveyor belt construction as such the combination of the sprockets in the rear side of the conveyor belt may be designed more or less robust. However, common for all these types of belts is that they need to have a dedicated point of attack on the underside of the belt in order to be able to transfer the torque force from the drive motor to the conveyor belt.

Typically, in the areas where the sprockets are supposed to engage the underside of the modular belt link a cavity or ridge is provided such that it becomes impossible to provide apertures in which rollers or balls may be mounted in this section. Therefore, the modular conveyor belts will have a rather large portion of its underside reserved for engaging sprockets.

A further aspect which has to be addressed by the modular belt links is the inherent strength in the conveyor belt module. The strength is required partly due to the transfer of force of one modular belt link to the other and in order to distribute the force, particularly the torque, from the sprocket's engagement with the underside of the conveyor belt to the rest of the conveyor belt.

Also depending on the load which the conveyor belt is designed to propel the modular belt links need to be strong enough to address these requirements.

### OBJECT OF THE INVENTION

The present invention is directed to this type of modular belt link, but is particular in that it is addressing a need to increase the numbers/area of rollers and balls such that the overall friction for items carried on the conveyor belt may be reduced substantially and at the same time a substantial support for items carried on the conveyor is provided.

It is clear that whereas a flat modular belt link is able to carry items on the entire surface a modular belt link provided with one or two balls will have the balls projecting from the surface and therefore the highest points on the carrying surface will be the apexes of the balls and as such the item carried on the conveyor belt will be carried in one or more points instead of a flat surface. This causes special requirements to the items being carried on the conveyor belt in order to ensure that these items are not damaged due to the transport on the conveyor.

Consequently, the present invention addresses this need by providing a modular belt link having a body section, said body section having a forward side and a rearward side, and lateral sides connecting said forward and rearward sides, where said body section has a thickness between a top surface and a rear surface, and further that means are provided along said forward and rearward sides for connecting the modular belt link to other substantially identical modular belt links arranged before and after said modular belt link, characterized in that a plurality of apertures through the thickness are provided, said apertures being suitable to receive and retain a ball or roller rotatably in each aperture, such that the balls or rollers extend or may be brought to extend above the top surface of the body section where a first plurality of apertures are separated by a mutual first distance x and one or more second apertures are provided spaced from said first plurality of apertures, where when more second apertures are provided they are separated by a mutual second distance y and the distance y from an adjacent aperture of the first plurality of apertures, and where in the rear surface at least partly into the thickness of the body section one or more cavities suitable to receive sprockets is/are arranged in between at least some of the apertures arranged with the second distance y, and where the first distance x is too short to allow cavities suitable to be engaged by sprockets.

Particularly the fact that a first plurality of apertures are arranged very closely, i.e. with a distance smaller than the width of a sprocket wheel provides the possibility that a substantial part of the overall surface of a modular belt link is provided with balls or rollers such that although the apex of a ball and roller does provide a point respectively a line of contact with for example a cardboard box being carried on the conveyor the sheer number of carrying points will substantially diminish the impact of a ball on the underside of a box to be carried and thereby have a more lenient handling of goods on the conveyor belt.

The fact that the distances x and y are dimensioned such that the distance y for example allows for a cavity suitable to be engageable by a sprocket wheel is to be understood in the sense that as already explained above the sprocket wheels are the means by which the torque from the drive motor is transferred to the underside of the conveyor belt and thereby providing the propelling force for the conveyor belt. For this reason the cavity needs to have a certain size in order to accommodate the sheer size of a suitable sprocket wheel but also needs to be strong enough such that the sprocket teeth are able to transfer sufficient force to the conveyor belt in the cavity.

In a further advantageous embodiment of the invention the first plurality of apertures comprises apertures arranged in one or more lines parallel to the forward side.

This particular embodiment is particularly advantageous where the length in the travelling direction of the conveyor belt is very short, i.e. the distance from the front side to the rear side is relatively short.

In a still further advantageous embodiment of the invention the first plurality of apertures are off-set arranged around a line parallel to the forward and rearward sides, such that the apertures alternates being closer to the front side and the rear side.

This particular embodiment is suitable when the distance between the forward side and the rearward side is somewhat larger whereby off-setting the apertures in a zig-zag pattern across a part of the top surface it is possible to accommodate a larger number of balls or rollers in the top surface of the modular belt link.

In the embodiment where the lateral distance between the closest apertures in the first plurality of apertures and the second plurality of apertures is the second distance y, it is foreseen that on the underside of the modular belt link two cavities suitable to be engaged by a sprocket wheel may be accommodated due to the two distances of y; the first distance of y between the first plurality and a first aperture in a second plurality and the second distance of y between two apertures in a second plurality.

In a still further advantageous embodiment of the invention balls are arranged in the apertures where the diameter of each ball is between 40% and 85% of the shortest distance between the front side and the rear side, preferably 50% to 65% and most preferred between 55% and 60%.

In this manner a substantial part of the top surface of each modular belt link becomes a friction-less surface by the provision of a ball in the many apertures.

In a practical embodiment an example of a ball diameter for applications has a diameter of 12.7 mm With the above mentioned ratios between the diameter of the ball and the modular belt links extend in the traveling direction (not taking into account the extending eye parts), the modular belt links will have a length of between 14.7 mm and 31.75 mm. It is therefore clear that adjacent balls in adjacent modular belt links, also in the travelling direction of the belt will be very closely spaced, and thereby provide a reduced friction.

In a still further advantageous embodiment of the invention the first plurality of apertures and the one or more second apertures constitute between 20% and 70% of the top surface area of the modular belt link. In this embodiment it is evident that a substantial part of the top surface is constituted by apertures and as such by the provision of friction-less carrying elements in the shape of balls and rollers whereas the integrity and strength of the modular belt link itself must be provided by the remaining area of the modular belt link not being apertures.

In a still further advantageous embodiment of the modular belt link the top surface adjacent each lateral side is provided with a flat section, said flat section being delimited by the lateral side and an edge parallel to the lateral side distanced z from the lateral side where the flat section is inclined with respect to the top side.

Particularly when moving items laterally onto or off the conveyor belt the inclined flat section may help in elevating an item being pushed onto the modular belt link/conveyor by inclining the flat section sufficiently such that the top of the inclined section is at the same level as the top of the balls or rollers arranged in the apertures in the modular belt link.

In some embodiments the flat section is inclined between 4° and 8° relative to the top surface, but any suitable angle creating a suitable inclination must of course be contemplated within this concept.

Further advantageous embodiments are set out in the remaining dependent claims.

The invention is also directed to a conveyor belt assembled from modular belt links as described above where the conveyor belt comprises a number of rows of modular belt links, where each row laterally may comprise a plurality of modular belt links, where when each row comprises two or more belt links, the belt links in one row are constructed by arranging an edge link consisting of only second apertures, said edge link having half the lateral width of the lateral width of a modular belt link, where the following lateral modular belt link is arranged with lateral side adjacent the first apertures towards the edge link, and the following lateral modular belt link is arranged with lateral side adjacent the first apertures towards the previous link and so on across the width of the conveyor belt, and where the adjacent row is provided with the rear side of a modular belt link engaging a side of an edge link with the second apertures in the same lateral orientation as the edge link and the following lateral modular belt link is arranged with the lateral side adjacent the second apertures towards the previous link and so on across the width of the conveyor belt, whereby the conveyor belt will have zones in the travelling direction of the conveyor belt where a zone only comprises second apertures and adjacent zones only comprising first apertures. In this manner by providing an edge link in every other row the rows becomes offset (bricklaying pattern). Furthermore as the modular belt links are turned 180° with respect to the intended travelling direction in each adjacent row, longitudinal zones with first apertures and second apertures respectively are provided, such that the sprocket wheels—usually arranged under the transport surface, engages the cavities provided between the second apertures, which are now arranged in longitudinal zones.

### DESCRIPTION OF THE DRAWING

The invention will now be described with reference to the accompanying drawings wherein

FIG. 1 illustrates a modular belt link according to the present invention

FIG. 2 illustrates the underside of the modular belt link in perspective

FIG. 3 illustrates a connection of the modular belt link to other substantially identical modular belt links

FIGS. 4A and 4B illustrates a schematic cross-section through an aperture provided with a ball

FIG. 5 illustrates a further embodiment of the invention

FIG. 6 illustrates a belt link with rollers and balls

### DETAILED DESCRIPTION OF THE INVENTION

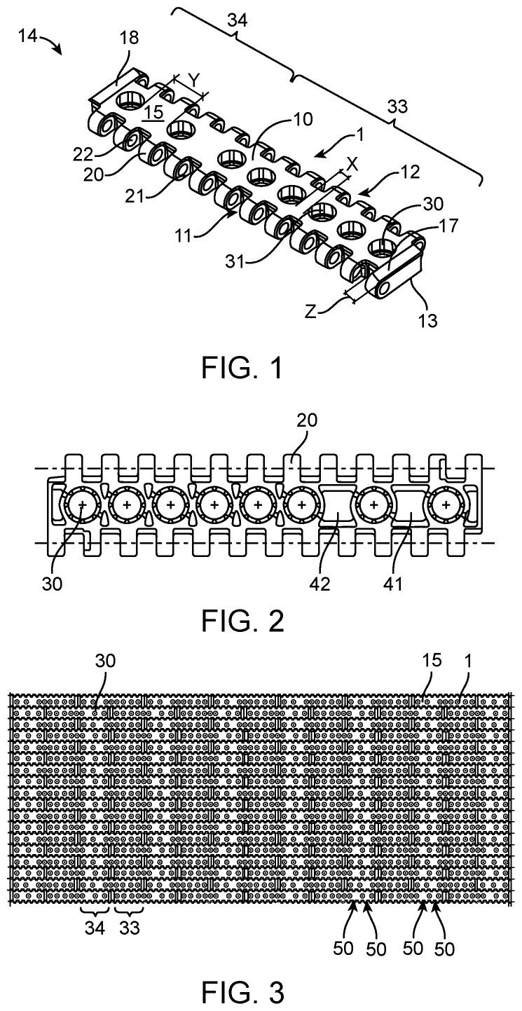

In FIG. 1 is illustrated a modular belt link 1 according to the present invention. The modular belt link 1 has a body section 10 where the body section 10 has a forward side 11 and a rearward side 12. In this connection it is clear that the definition of forward and rearward is only used to distinguish the two sides and that in practice the conveyor belt assembled from a plurality of modular belt links 1 according to the present invention, for example as illustrated with reference to FIG. 3, may travel in both directions and is not limited to travel in a forward or rearward direction.

Furthermore, lateral sides 13, 14 are provided where the lateral sides 13, 14 connect the forward and rearward sides 11, 12. The body section has a thickness between a top surface 15 and a rear surface. Furthermore, means are provided along the forward and rearward sides 11, 12 for connecting the modular belt link 1 to other substantially identical modular belt links 1 as illustrated with reference to FIG. 3.

Turning back to FIG. 1 the top surface 15 adjacent the lateral sides 13, 14 is provided with a flat section 17, 18. The flat section 17 is delimited by an edge distanced z away from the lateral side 13, 14 such that a surface area is provided. Preferably the surface area 17, 18 is inclined with respect to the top surface 15 such that the flat section has its lowest edge along the lateral sides 14, 13 and thereafter ascends. The incline makes it easier for goods which are forced laterally onto the conveyor belt to be led upwards to the apex level of the balls/rollers accommodated in the apertures. In this manner it becomes easier to slide objects to be transported by the conveyor belt onto the conveyor belt and/or the rollers.

In this particular embodiment the means are in the shape of eye parts 20 where adjacent eye parts 20 on the forward or rearward side 11, 12 are separated by a space 21 corresponding to the lateral width of an eye part 20. In this manner it is possible to interleave adjacent modular belt links 1 such that eye parts on a rear side may be accommodated in the spaces 21 on a forward side. Furthermore, the eye parts are provided with apertures 22 such that when two adjacent modular belt links 1 are interleaved the apertures 22 will overlap laterally through the entire width of the belt link making it possible to insert a connection pin (not illustrated) through the overlapping eye parts thereby connecting adjacent modular belt links 1 in a hinge-like manner as illustrated in FIG. 3.

A plurality of apertures 30 are provided through the thickness of the modular belt link 1. In this embodiment the apertures 30 are substantially circular such that in use they may accommodate a ball, but the apertures 30 may also have an elongated cross-section such that they can accommodate rollers. The apertures 30 are provided with means 31 such that a ball may be retained inside the aperture 30 but at the same time the friction between the ball and the aperture is so low that it is possible to substantially frictionless rotate the ball in the aperture.

In a first section 33 a first plurality of apertures 30 are separated by the distance X and in a second section 34 the apertures are separated by a second distance Y. In this manner it is clear that part of the surface 15 of the modular belt link has more surface area than another part of the surface of the modular belt link.

By providing the distance Y between apertures in the second section 34 it may with reference to FIG. 2 be possible to provide cavities 41, 42 in the underside of the modular belt link. In this connection FIG. 2 illustrates the underside of the modular belt link illustrated in perspective in FIG. 1. The apertures 30 are through-going apertures and as such leave little on the top and rear side surface area vacant. The cavities 41, 42 are provided such that sprocket wheels may engage and propel the modular belt link and thereby the entire conveyor belt.

As should be evident the apertures 30 suitable to receive balls or in other embodiments where the apertures are elongated rollers constitute a rather large portion of the surface area and as such are able to provide a substantial amount of support points for goods carried on the conveyor. In FIG. 3 is illustrated a section of an endless conveyor belt assembled from modular belt links 1 as illustrated in FIG. 1. Due to the distribution of apertures 30 in the upper side 15 of the modular belt links and separating the apertures into sections 34 and 33 where the apertures have different distances X, Y when assembled in a bricklaying pattern the assembled conveyor belt will provide lanes 50 free from apertures and thereby rollers and balls. These lanes 50 coincide with the cavities 41, 42 provided in the underside such that it is clear that sprocket wheels arranged on the drivel axles used to propel the conveyor belts will engage the conveyor belt in these lanes.

As may further be seen from FIG. 3 the top surface 15 of the conveyor belt is provided with a large number of bearing points in that the balls or rollers inserted in the apertures are closely arranged such that a very supportive, but yet frictionless surface is provided in a conveyor belt structure according to the present invention and as depicted in FIG. 3.

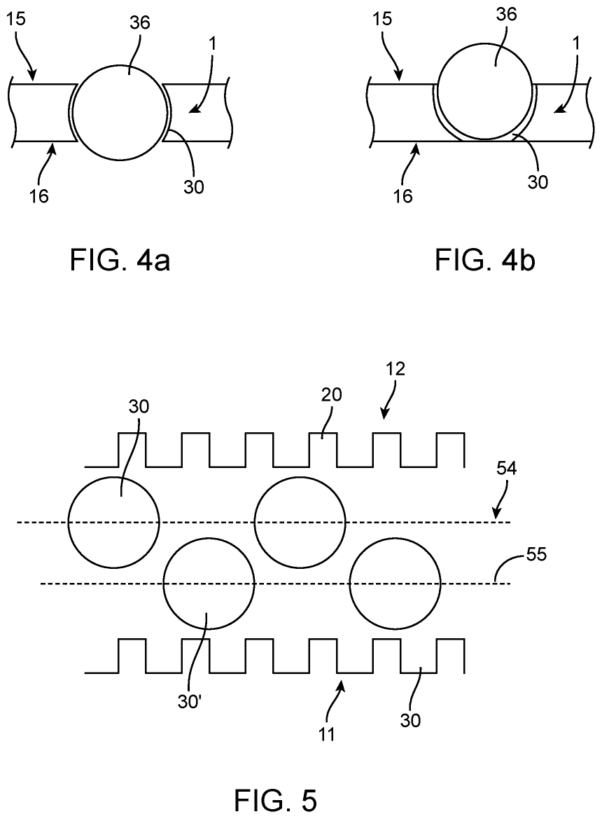

Turning to FIGS. 4A and 4B a schematic cross-section through an aperture 30 provided with a ball 36 is illustrated. In FIG. 4A it is clear that the ball extends above the top surface 15 of the modular belt link which is also the case with the ball 36 in FIG. 4B.

In FIG. 4A, however, the ball also extends below the underside of the modular belt link whereas in FIG. 4B the underside of the ball 36 is substantially flush with the underside of the modular belt link 1. Such an arrangement may be used for various purposes in that with the configuration as illustrated with reference to FIG. 4A it is possible to activate the ball 36, for example by having a surface or another conveyor belt engage the underside of the conveyor belt 1 such that the ball comes into frictional engagement with this surface (not illustrated). As the modular belt link moves relative to this engagement surface the ball 36 will be brought to rotate.

Consequently, items carried on the top side of the belt on the apex of the balls 36 will be rotated, for example laterally, with respect to the conveyor belt. In the embodiment illustrated with reference to FIG. 4B the balls may rotate independently of the modular belt link 1. These types of belts are often used as accumulating belts such that items carried on the conveyor which are brought against a stop will cause the balls 36 to rotate while the conveyor belt still continues forward.

In a further embodiment of the invention another layout is illustrated in FIG. 5 where the apertures 30 are offset from adjacent apertures 30′, but apertures in one row are arranged with a central axis 54 indicated by dashed lines whereas apertures 30′ in a second row are arranged along another axis 55. In this manner it becomes possible to accommodate even more balls or rollers per square meter in the surface of a conveyor belt, but also to make the modular belt links longer measure from the forward side to the rearward side.

The centre or centre axis of balls resp. rollers could also be arranged symmetrically off-set from a single axis.

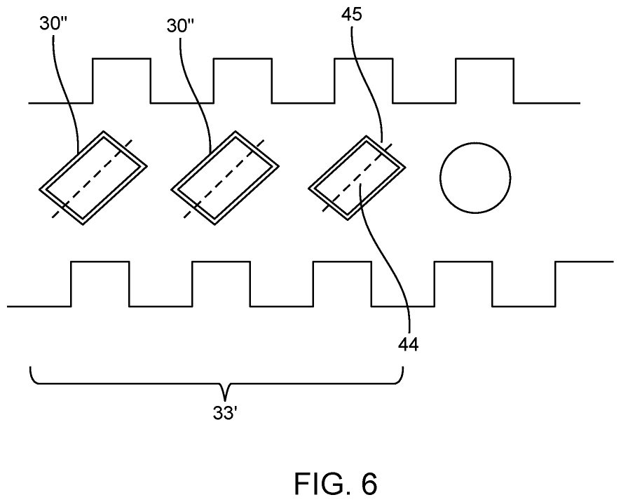

In FIG. 6 is illustrated an embodiment where the apertures 30″ in the first section 33′ are rectangular adapted to receive rollers 44, in this embodiment arranged for rotation around the axis indicated by dashed lines 45. Other orientations or the rollers may also be contemplated. The apertures in the second section may likewise be shaped to accommodate rollers as desired.

1. A modular belt link having a body section, said body section having a forward side and a rearward side, and lateral sides connecting said forward and rearward sides, where said body section has a thickness between a top surface and a rear surface, and further that means are provided along said forward and rearward sides for connecting the modular belt link to other substantially identical modular belt links arranged before and after said modular belt link, wherein a plurality of apertures through the thickness are provided, said apertures being suitable to receive and retain a ball or roller rotatably in each aperture, such that the balls or rollers extend or may be brought to extend above the top surface of the body section where a first plurality of apertures are separated by a mutual first distance x and one or more second apertures are provided spaced from said first plurality of apertures, where when more second apertures are provided they are separated by a mutual second distance y and the distance y from an adjacent aperture of the first plurality of apertures, and where in the rear surface at least partly into the thickness of the body section one or more cavities suitable to receive sprockets is/are arranged in between at least some of the apertures arranged with the second distance y, and where the first distance x is too short to allow cavities suitable to be engaged by sprockets.

2. The modular belt link according to claim 1, wherein the first plurality of apertures comprises apertures arranged in one or more lines parallel to the forward side.

3. The modular belt link according to claim 1, wherein the first plurality of apertures are off-set arranged around a line parallel to the forward and rearward sides, such that the apertures alternates between being closer to the front side and the rear side.

4. The modular belt link according to claim 1, wherein the lateral distance between the closest apertures in the first plurality of apertures and the second plurality of apertures is the second distance y.

5. The modular belt link according to claim 1, wherein balls are arranged in the apertures, and where the diameter of each ball is between 40% and 85% of the shortest distance between the front side and the rear side, preferably 50% to 65% and most preferred between 55% and 60%.

6. The modular belt link according to claim 1, wherein the first plurality of apertures and the one or more second apertures constitute between 20% and 70% of the top surface area of the modular belt link.

7. The modular belt link according to claim 1, wherein the top surface adjacent each lateral side is provided with a flat section, said flat section being delimited by the lateral side and an edge parallel to the lateral side distanced z from the lateral side.

8. The modular belt link according to claim 7, wherein the flat section is inclined with respect to the top surface.

9. The modular belt link according to claim 1, wherein the means provided along said forward and rearward sides for connecting the modular belt link to other substantially identical modular belt links arranged before and after said modular belt link are eye parts, where eye parts projecting from the front side are spaced with a distance along the front side corresponding to the width of an eye-part, and where eye parts on the rear side are off-set the width of an eye part, such that eye parts on the front side of one modular belt link may be interleafed eye parts on the rear side of an adjacent modular belt link, and where all eye parts are provided with an aperture parallel to the front side, such that when eye parts of adjacent modular belt links are interleafed a continuous aperture is provided across the modular belt links, and where a connection pin is inserted in the overlapped apertures through the eye parts, thereby connecting adjacent modular belt links in a hinge like manner.

10. The modular belt link according to claim 1, wherein four to eight apertures are provided in the first plurality of apertures and where one to five second apertures are provided.

11. The modular belt link according to claim 1, wherein balls or a combination of balls and rollers or only rollers are provided in the apertures, where said apertures has corresponding shapes as the balls and/or rollers.

12. A conveyor belt assembled from a plurality of modular belt links according to claim 1, where the conveyor belt comprises a number of rows of modular belt links, where each row laterally may comprise a plurality of modular belt links, where when each row comprises two or more belt links, the belt links in one row are constructed by arranging an edge link consisting of only second apertures, said edge link having half the lateral width of the lateral width of a modular belt link, where the following lateral modular belt link is arranged with lateral side adjacent the first apertures towards the edge link, and the following lateral modular belt link is arranged with lateral side adjacent the first apertures towards the previous link and so on across the width of the conveyor belt, and where the adjacent row is provided with the rear side of a modular belt link engaging a side of an edge link with the second apertures in the same lateral orientation as the edge link and the following lateral modular belt link is arranged with the lateral side adjacent the second apertures towards the previous link and so on across the width of the conveyor belt, whereby the conveyor belt will have zones in the travelling direction of the conveyor belt where a zone only comprises second apertures and adjacent zones only comprising first apertures.
